(19) United States
(12) Patent Application Publication
(10) Pub. No.: US 2011/0252382 A1
(43) Pub. Date: Oct. 13, 2011

(54) PROCESS PERFORMANCE USING A PEOPLE CLOUD

(75) Inventors: Kumar Bhaskaran, Englewood Cliffs, NJ (US); Jim A. Laredo, Katonah, NY (US); Vijay K. Naik, Pleasantville, NY (US); Maja Vukovic, New York, NY (US)

(73) Assignee: INTERNATIONAL BUSINESS MACHINES CORPORATION, Armonk, NY (US)

(21) Appl. No.: 12/755,611

(22) Filed: Apr. 7, 2010

(51) Int. Cl. G06F 9/44; G06F 3/048; G06F 17/30

(52) U.S. Cl. 715/853; 707/769; 717/101; 707/E17.014

(57) ABSTRACT

A method, data processing system, and computer program product are present for managing projects in a network data processing system. A computer system identifies a plurality of tasks for a project. The computer system creates a model for the project using the plurality of tasks. The model identifies people to perform the plurality of tasks. The computer system selects a group of people with knowledge about the plurality of tasks. The computer system sends a number of requests to the group of people to update the model of the project. The number of requests includes the model. The computer system updates the model of the project using a number of responses in response to receiving the number of responses to the number of requests.

### BACKGROUND

1. Field

The disclosure relates generally to an improved data processing system and, in particular, to a method and apparatus for processing data. Still more specifically, the present disclosure relates to a method and apparatus for performing processes on a network data processing system using a people cloud.

2. Description of the Related Art

Network data processing systems are used by organizations to offer services. These services may include, for example, software development, consulting services, offering products for sale, and other suitable services. These different services are offered through the performance of processes run on the network data processing system. The different processes to run or provide services may be referred to as projects. For example, if the service offered includes software development, multiple processes are performed using the network data processing system to write code for software. A project may involve writing code for a particular client.

For example, in performing the project, servers may be set up for programmers to write code for an application. Other servers may be set up in the network data processing system to perform testing and troubleshooting of the software for the project. Still other processes may be set up on the network data processing system to deliver the completed software product to a customer or client.

As another example, as the consulting service is offered to customers, different experts in the organization may be selected and organized to perform different tasks in a process to provide the consulting service to a customer. For example, the organization may provide advice on migrating a customer from a local area network or a wide area network to a cloud computing system as a project. In this example, the project may include making an analysis of the costs and benefits for the transition. Further, a recommendation as to a type of cloud also may be made.

For example, the analysis may indicate that a private cloud may be more suited for the particular customer as opposed to a public cloud, depending on the client's requirements for security, corporate governance, reliability, or other parameters.

### SUMMARY

In the illustrative embodiments, a method, data processing system, and computer program product are present for managing projects in a network data processing system. A computer system identifies a plurality of tasks for a project. The computer system creates a model for the project using the plurality of tasks. The model identifies people to perform the plurality of tasks. The computer system selects a group of people with knowledge about the plurality of tasks. The computer system sends a number of requests to the group of people to update the model of the project. The number of requests includes the model. The computer system updates the model of the project using a number of responses in response to receiving the number of responses to the number of requests.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is an illustration of a data processing system in accordance with an illustrative embodiment;

FIG. 3 is an illustration of a people cloud environment in accordance with an illustrative embodiment;

FIG. 4 is an illustration of the people involved in performing a project in accordance with an illustrative embodiment;

FIG. 5 is an illustration of a block diagram of a project in accordance with an illustrative embodiment;

FIG. 6 is an illustration of a model for a project in accordance with an illustrative embodiment;

FIG. 7 is an illustration of a project architecture in accordance with an illustrative embodiment;

FIG. 8 is an illustration of a flowchart of a process for managing projects in a network data processing system in accordance with an illustrative embodiment; and

FIG. 9 is an illustration of a process for updating a project graph in accordance with an illustrative embodiment.

### DETAILED DESCRIPTION

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, the present invention may take the form of a computer program product embodied in any tangible medium of expression having computer usable program code embodied in the medium.

Any combination of one or more computer usable or computer readable medium(s) may be utilized. The computer usable or computer readable medium may be, for example, but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CDROM), an optical storage device, a transmission media, such as those supporting the Internet or an intranet, or a magnetic storage device. Note that the computer usable or computer readable medium could even be paper or another suitable medium upon which the program is printed, as the program can be electronically captured via, for instance, optical scanning of the paper or other medium, then compiled, interpreted, or otherwise processed in a suitable manner, if necessary, and then stored in a computer memory. In the context of this document, a computer usable or computer readable medium may be any medium that can contain, store, communicate, propagate, or transport the program for use by or in connection with the instruction system, apparatus, or device. The computer usable medium may include a propagated data signal with the computer usable program code embodied therewith, either in baseband or as part of a carrier wave. The computer usable program code may be transmitted using any appropriate medium, including, but not limited to, wireless, wireline, optical fiber cable, RF, etc.

Computer program code for carrying out operations of the present invention may be written in any combination of one or more programming languages, including an object-oriented programming language, such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowcharts and/or block diagrams of methods, apparatus (systems), and computer program products according to embodiments of the invention. It will be understood that each block of the flowcharts and/or block diagrams, and combinations of blocks in the flowcharts and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer or other programmable data processing apparatus to function in a particular manner, such that the instructions stored in the computer readable medium produce an article of manufacture including instruction means, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

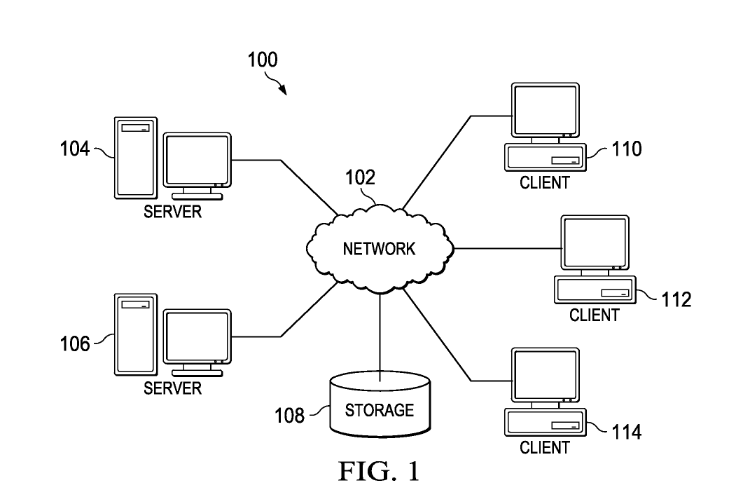

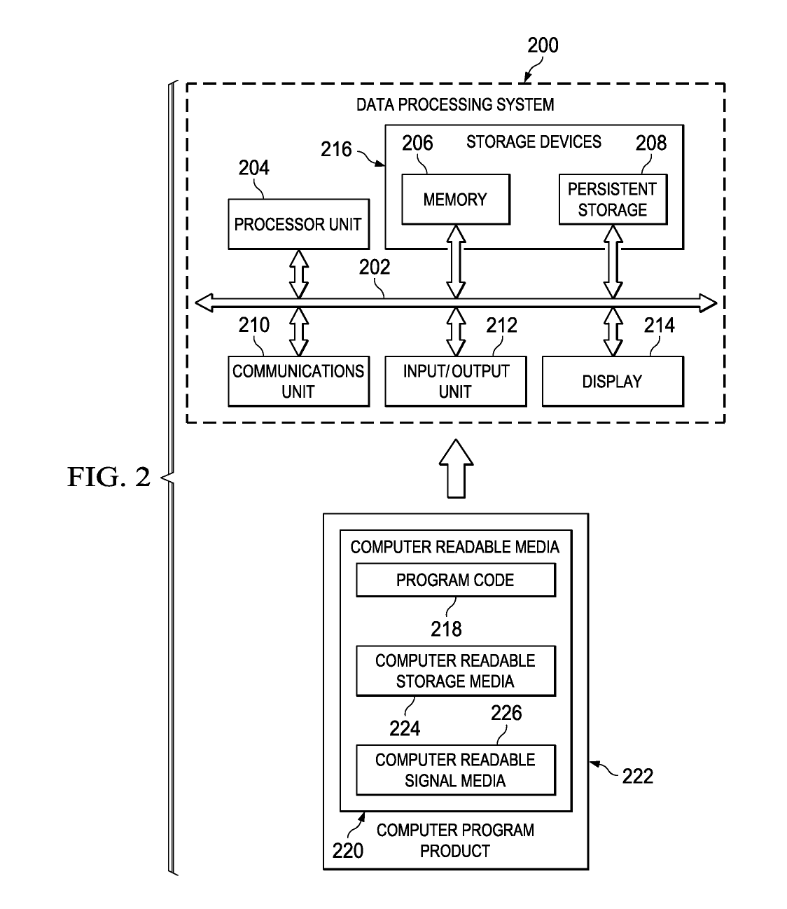

With reference now to the figures and, in particular, with reference to FIGS. 1-2, exemplary diagrams of data processing environments are depicted in which illustrative embodiments may be implemented. It should be appreciated that FIGS. 1-2 are only examples and are not intended to assert or imply any limitations with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

Program code located in network data processing system 100 may be stored on a computer recordable storage medium and downloaded to a data processing system or other device for use. For example, program code may be stored on a computer recordable storage medium on server 104 and downloaded to client 110 over network 102 for use on client 110.

Illustrative embodiments may be implemented using network data processing system 100. For example, program code embodying one or more features of the different illustrative embodiments may be run on network data processing system 100. Additionally, other steps or processes for the different illustrative embodiments also may be performed using network data processing system 100.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example and not as an architectural limitation for the different illustrative embodiments.

Turning now to FIG. 2, an illustration of a data processing system is depicted in accordance with an illustrative embodiment. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to implement instructions for software that may be loaded into memory 206. Processor unit 204 may be a number of processors or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms, depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

Communications unit 210, in these examples, provides for communication with other data processing systems or devices. In these examples, communications unit 210 is a network interface card. Communications unit 210 may provide communications through the use of either or both physical and wireless communications links.

Input/output unit 212 allows for the input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 or run by processor unit 204. The processes of the different embodiments may be performed by processor unit 204 using computer implemented instructions, which may be located in a memory, such as memory 206.

These instructions are referred to as program code, computer usable program code, or computer readable program code that may be read and run by a processor in processor unit 204. The program code, in the different embodiments, may be embodied on different physical or computer readable storage media, such as memory 206 or persistent storage 208.

Program code 218 is located in a functional form on computer readable media 220 that is selectively removable and may be loaded onto or transferred to data processing system 200 and run by processor unit 204. Program code 218 and computer readable media 220 form computer program product 222. In one example, computer readable media 220 may be computer readable storage media 224 or computer readable signal media 226. Computer readable storage media 224 may include, for example, an optical or magnetic disk that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory that is connected to data processing system 200. In some instances, computer readable storage media 224 may not be removable from data processing system 200.

Alternatively, program code 218 may be transferred to data processing system 200 using computer readable signal media 226. Computer readable signal media 226 may be, for example, a propagated data signal containing program code 218. For example, computer readable signal media 226 may be an electromagnetic signal, an optical signal, and/or any other suitable type of signal. These signals may be transmitted over communications links, such as wireless communications links, an optical fiber cable, a coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer readable signal media 226 for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of executing program code.

As one example, data processing system 200 may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub that may be present in communications fabric 202.

The different illustrative embodiments recognize and take into account a number of different considerations. For example, the different illustrative embodiments recognize that organizations providing services may perform complex and unique projects. These projects may require expertise from people in different areas of specialization. Further, the ability of an organization to provide these services within a desired timeframe for a client may determine whether the organization is offered the opportunity to perform the service.

With these types of situations, the ability of an organization to identify people to perform the processes for the project may be important in obtaining the project from the client. Further, an ability to make those members available for other projects as soon as the current project is over also may increase the ability of an organization to obtain more projects and perform more projects within a period of time.

The different illustrative embodiments recognize and take into account that currently, the organization of people into groups is performed on an ad hoc basis. Further, planning a resource allocation is performed far in advance by a management group. The different illustrative embodiments recognize that these types of techniques often are not quick enough to react to changing requirements of the client or to provide proposals to potential clients quickly enough to obtain a project from the client. For example, people may be selected to perform a project. The makeup of the people in the project may need to change based on changing requirements or situations while the project is being performed. Further, the identification and allocation of people for use on different projects also are not as efficient using currently available mechanisms for identifying people for projects.

Thus, the illustrative embodiments provide a method and apparatus for managing projects in a network data processing system. In a number of illustrative embodiments, a plurality of tasks for a project is identified. A model is created for the project using the plurality of tasks. The model identifies people to perform the plurality of tasks for the project. A current group of people with knowledge about the plurality of tasks and the model is identified. A number of requests is sent to the current group of people to update the model of the project. In response to receiving a number of responses to the number of requests, the model of the project is updated using the number of responses.

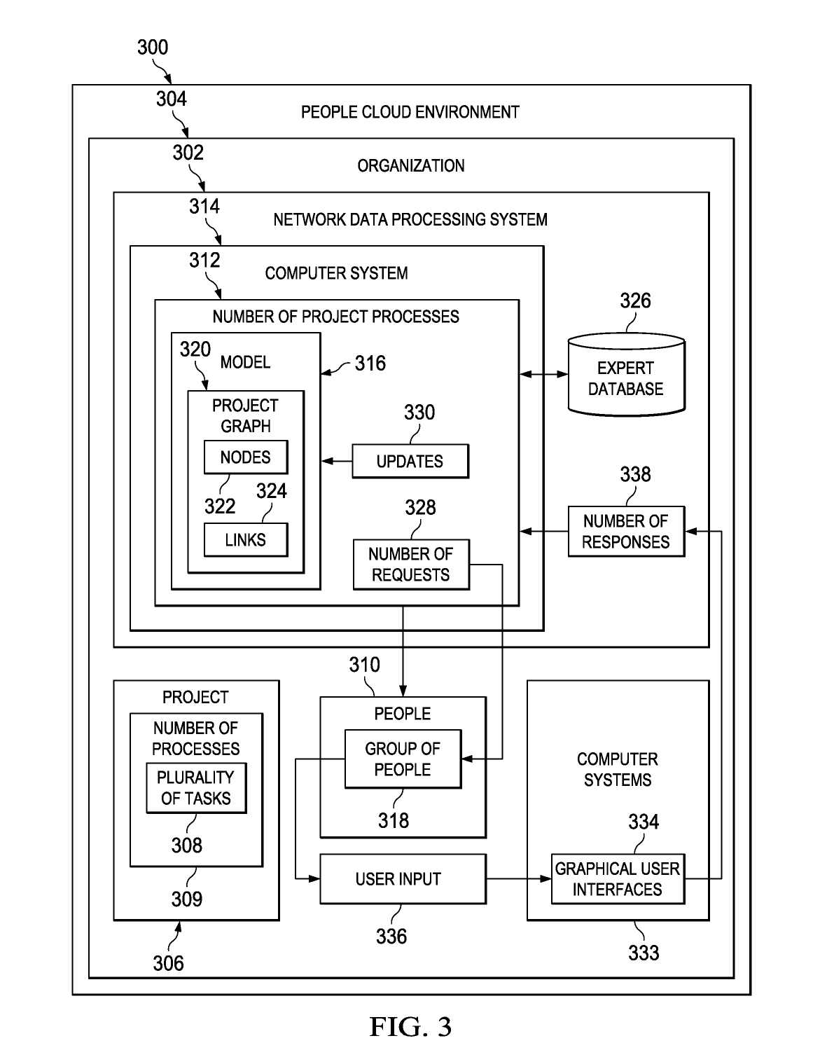

With reference now to FIG. 3, an illustration of a people cloud environment is depicted in accordance with an illustrative embodiment. People cloud environment 300 includes network data processing system 302. Network data processing system 100 in FIG. 1 is an example of a network data processing system that may be used to implement network data processing system 302. Network data processing system 302, in this illustrative example, is part of organization 304. Organization 304 may perform project 306.

Project 306 may take a number of different forms. For example, project 306 may be a consulting service for a client, a software programming project, or some other suitable type of project. In some cases, project 306 may be an ongoing project, such as, for example, an invoicing project, customer service, and other projects that may not have a definite end. In these illustrative examples, project 306 includes plurality of tasks 308. These tasks are performed by people 310.

Plurality of tasks 308 form number of processes 309 that are performed for project 306. Each person in people 310 may perform a number of tasks within plurality of tasks 308 in these examples.

In this illustrative example, when project 306 is identified for organization 304, number of project processes 312 runs on computer system 314 within network data processing system 302 to identify plurality of tasks 308 needed to perform project 306. Additionally, number of project processes 312 also identifies people 310 to perform plurality of tasks 308. In these illustrative examples, computer system 314 is a number of computers. In particular, number of project processes 312 may run on one processor unit within computer system 314 or multiple processor units.

Number of project processes 312 creates model 316 using plurality of tasks 308. In these illustrative examples, model 316 may take the form of project graph 320. Project graph 320 includes nodes 322 and links 324. Nodes 322 represent at least one of tasks, people to perform tasks, a combination of people and tasks, and other suitable information. Links 324 identify dependencies between nodes 322. In other words, links 324 may identify dependencies between tasks or people performing tasks in nodes 322.

As used herein, the phrase “at least one of”, when used with a list of items, means that different combinations of one or more of the listed items may be used and only one of each item in the list may be needed. For example, “at least one of item A, item B, and item C” may include, for example, without limitation, item A or item A and item B. This example also may include item A, item B, and item C, or item B and item C.

In these illustrative examples, nodes 322 may be initially populated with people 310 using expert database 326. Expert database 326 is a database of people who may have skills or knowledge to perform one or more of plurality of tasks 308. Expert database 326 may be in a single location or distributed over various locations.

In this illustrative example, number of project processes 312 identifies group of people 318. Group of people 318 is people with knowledge about plurality of tasks 308. After model 316 has been created and group of people 318 have been identified, number of project processes 312 sends number of requests 328 to group of people 318. Number of requests 328 is requests that group of people 318 provide updates 330 to model 316. Updates 330 may include a number of different types of updates. For example, updates 330 may add a node to nodes 332, add a link to links 324, delete a node from nodes 322, delete a link from links 324, change a value for a node within nodes 322, change a value for a link within links 324, add a value, or other suitable types of changes.

Number of requests 328 is received at computer systems 333 used by group of people 318. Number of requests 328 is displayed on graphical user interfaces 334 at computer system 333. Computer systems 333 may be part of network data processing system 302 in organization 304 in this illustrative example. In other illustrative examples, computer systems 333 may be located in other network data processing systems and/or other organizations. For example, computer systems 333 may be formed by computers for individuals that belong to a social network. In another example, computer systems 333 may be for an organization of experts in a particular technology.

In these illustrative examples, at least a portion of group of people 318 may enter user input 336 into at least a portion of graphical user interfaces 334 to provide updates 330 to model 316. User input 336 is returned as number of responses 338.

When number of responses 338 is received by number of project processes 312, number of project processes 312 takes user input 336 in number of responses 338 to perform updates 330 to model 316. When model 316 is complete, people 310 are complete for project 306. At this time, project 306 may begin.

The illustration of people cloud environment 300 in FIG. 3 is not meant to imply physical or architectural limitations to the manner in which different illustrative embodiments may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

For example, in some illustrative examples, number of project processes 312 may be implemented as a service for organization 304. In other words, number of project processes 312 may run on a computer system at a location remote to network data processing system 302. Number of project processes 312 may be used to provide a service to organization 304 to organize and identify people 310 to perform project 306.

In some illustrative examples, project 306 may begin before model 316 is complete. For example, if people 310 are identified for tasks that are earlier in project 306, performance of project 306 may begin before all of people 310 are identified for project 306. Further, during the performance of project 306, changes may occur such that modifications to model 316 may be required. For example, customer requirements may change, some people in people 310 identified for project 306 may become unavailable, other resources may change in amount, type, or availability, and other changes may occur requiring modifications to model 316.

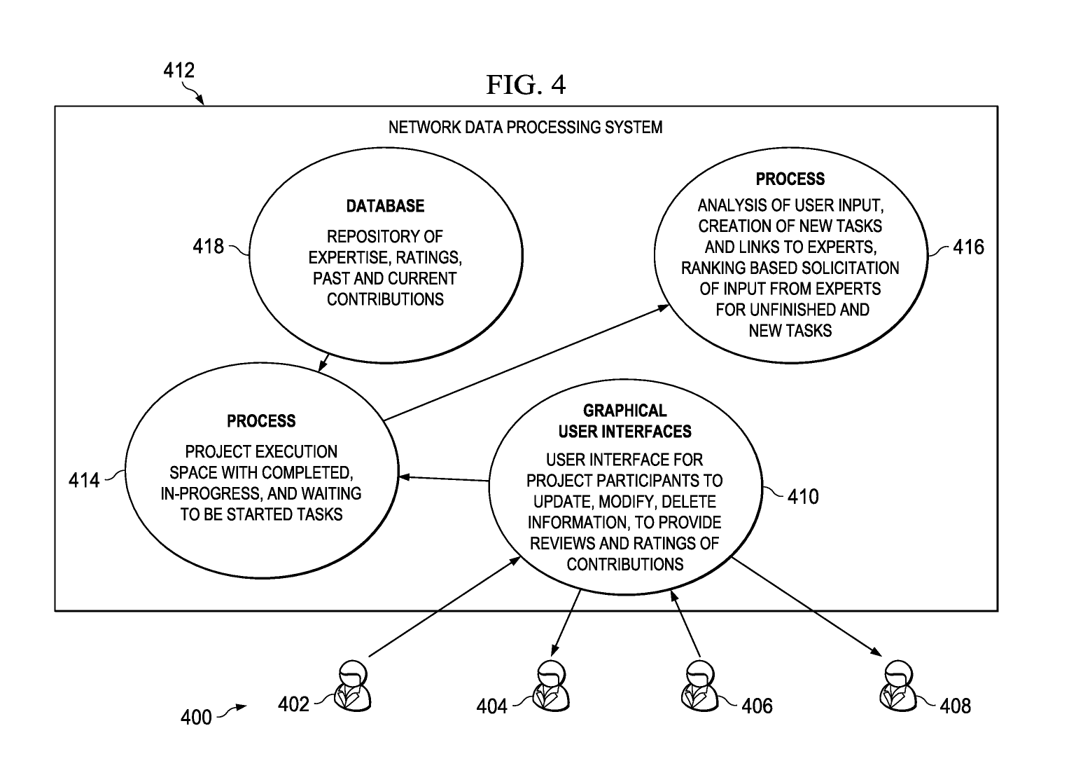

With reference now to FIG. 4, an illustration of the people involved in performing a project is depicted in accordance with an illustrative embodiment. In this illustrative example, people 400 are involved with performing and managing a project, such as project 306 in FIG. 3. People 400 may include people, such as people 310 in FIG. 3.

As depicted in this example, people 400 include person 402, person 404, person 406, and person 408. People 400 provide information for managing the project using graphical user interfaces 410. For example, person 402 provides updates for the tasks for the projects using graphical user interfaces 410. These updates may include, for example, updates regarding the completion of tasks. Person 406 reviews tasks for the project using graphical user interfaces 410. For example, person 406 may make changes to the tasks for the project, add tasks for the project, and/or remove tasks for the project.

In this illustrative example, person 404 may be solicited for new user input for the project using graphical user interfaces 410. The user input may be information required for performing any of a number of tasks for the project. Person 408 may receive project status reports for the project using graphical user interfaces 410.

In this illustrative example, graphical user interfaces 410 are associated with network data processing system 412. Network data processing system 412 may be, for example, network data processing system 302 in FIG. 3. Graphical user interfaces 410 may be part of a computer system in network data processing system 302.

User input received at graphical user interfaces 410 is used by processes running on network data processing system 412. These processes may be run on a computer system different than the computer system for graphical user interfaces 410. For example, network data processing system 412 runs project process 414, project process 416, and database 418.

Project process 414 receives the user input received through graphical user interfaces 410. Project process 414 uses this user input to manage the performance of the project. For example, project process 414 keeps track of the status of the tasks for the project. The status may be one of, for example, completed, in-progress, or waiting to be started. Further, project process 414 may manage a model for the project. The model may be, for example, model 316 in FIG. 3.

In this depicted example, project process 414 queries database 418 for information about people having knowledge about the tasks for the project. Database 418 may include, for example, an identification of experts having knowledge about the different tasks, ratings for the experts, past contributions of the experts to past projects, current contributions of the experts to the current project, and/or other suitable information.

After receiving the information from database 418, project process 414 sends information to project process 416. Project process 416 analyzes the user input received through graphical user interfaces 410. Based on the user input, project process 416 performs different operations. For example, project process 416 may create new tasks for the project and/or change tasks. Project process 416 may also generate a number of requests for a group of people having knowledge about the tasks for the project. The group of people may be selected using the information received from database 418. For example, the group of people may be selected based on ratings of the experts identified in database 418.

The information generated by project process 416 is sent to and received by project process 414. Project process 414 uses the information from project process 416 to make changes to the model for the project. Requests for the group of people are sent to at least a portion of people 400 using graphical user interfaces 410.

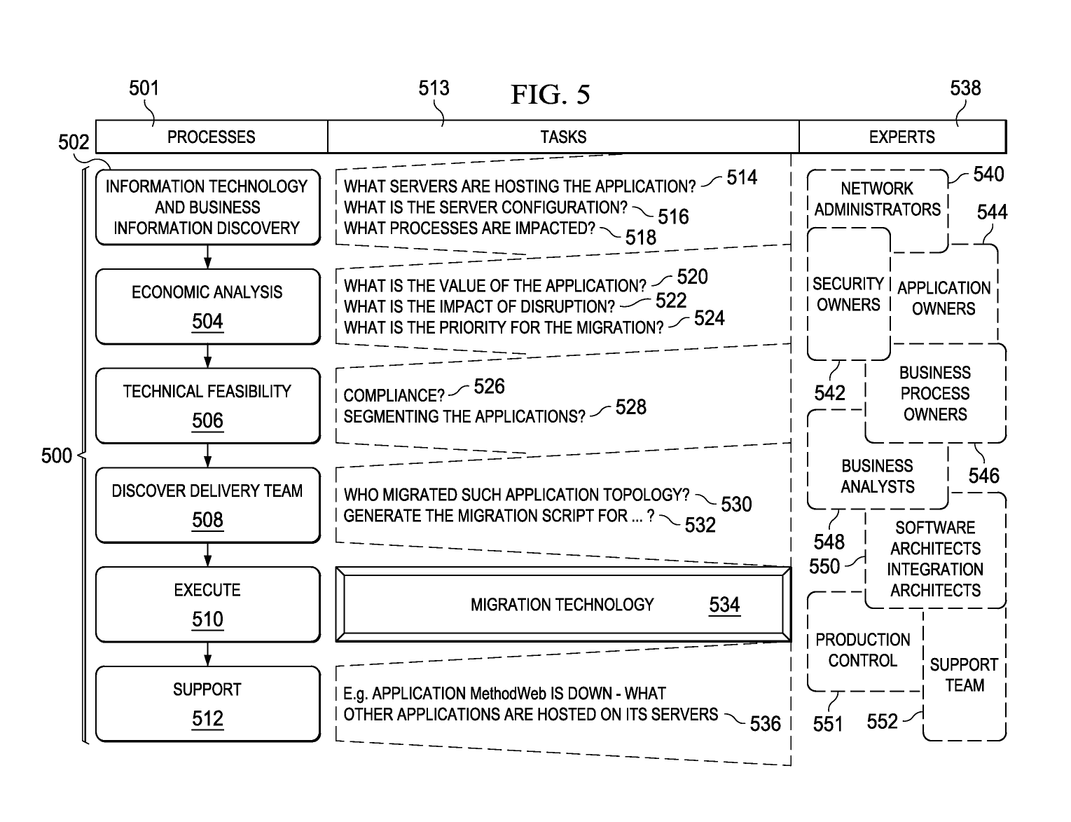

With reference now to FIG. 5, an illustration of a block diagram of a project is depicted in accordance with an illustrative embodiment. In this illustrative example, project 500 is an example of one implementation of project 306 in FIG. 3. Project 500 may be performed to implement a new software application in an existing computer system. The existing computer system may be, for example, data processing system 200 in FIG. 2 and/or network data processing system 302 in FIG. 3. The implementation of the new software application in the existing computer system may be referred to as a migration of the new software application.

As depicted, project 500 includes number of processes 501. Number of processes 501 is an example of one implementation for number of processes 309 in FIG. 3. Number of processes 501 includes information technology and business information discovery 502, economic analysis 504, technical feasibility 506, discovery of delivery team 508, execution 510, and support 512. In this illustrative example, number of processes 501 is formed by tasks 513.

For example, information technology and business information discovery 502 includes tasks 514, 516, and 518. Task 514 is performed to determine which servers are hosting the new software application. Task 516 is performed to identify a configuration for the servers hosting the new software application. Task 518 is performed to determine which processes in the existing computer system may be impacted by the implementing of the new software application in the existing computer system.

Economic analysis 504 includes tasks 520, 522, and 524. Task 520 is performed to determine the economic value of the application. Task 522 is performed to determine the financial impact that disrupting the existing computer system to implement the new software application may have. Task 524 is performed to determine the priority level for project 500. In other words, task 524 is performed to determine how soon the new software application should be implemented in the existing computer system.

Technical feasibility 506 includes tasks 526 and 528. Task 526 is performed to determine whether the new software application will comply with the existing computer system. In other words, task 526 is performed to determine whether the new software application will adhere to a set of rules, policies, and/or requirements for the existing computer system. Task 528 is performed to determine whether the new software application should be segmented for implementation in the existing computer system.

Discovery of delivery team 508 includes tasks 530 and 532. Task 530 is performed to identify the people involved in implementing the new software application and configuring the new software application for use in the existing computer system. Task 532 is performed to identify the people who generated the program code allowing the new software application to be implemented in the existing computer system. This program code may be referred to as, for example, a migration script. The migration script may be used to move data, software applications, and other information from one computer system to another computer system.

Execution 510 includes task 534. Task 534 is performed to perform the implementation of the new software application in the existing computer system. In other words, task 534 is performed to perform migration of the new software application. Support 512 includes task 536. Task 536 is performed to provide technical support for the new software application. For example, the technical support may include determining other applications that may be hosted on the servers when the new software application is not operating as desired.

In this illustrative example, the different tasks for number of processes 501 may be performed by experts 538. Experts 538 include network administrators 540, security owners 542, application owners 544, business process owners 546, business analysts 548, software and integration architects 550, production controllers 551, and support team members 552. Experts 538 form a people cloud in these illustrative examples. Different experts in experts 538 may have the knowledge to perform the different tasks for number of processes 501. Some experts in experts 538 may have the knowledge to perform more than one task. In some cases, more than one expert in experts 538 may be needed to perform one task.

For example, network administrators 540 and security owners 542 may have the knowledge to perform task 514 and task 516 for information technology and business information discovery 502. Tasks 520, 522, and 524 for economic analysis 504 may require knowledge from application owners 544, business process owners 546, and business analysts 548.

As another illustrative example, software and integration architects 550 may have the knowledge and ability to perform task 534 for execution 510. Support team 552 may have the knowledge and ability to perform task 536 for support 512.

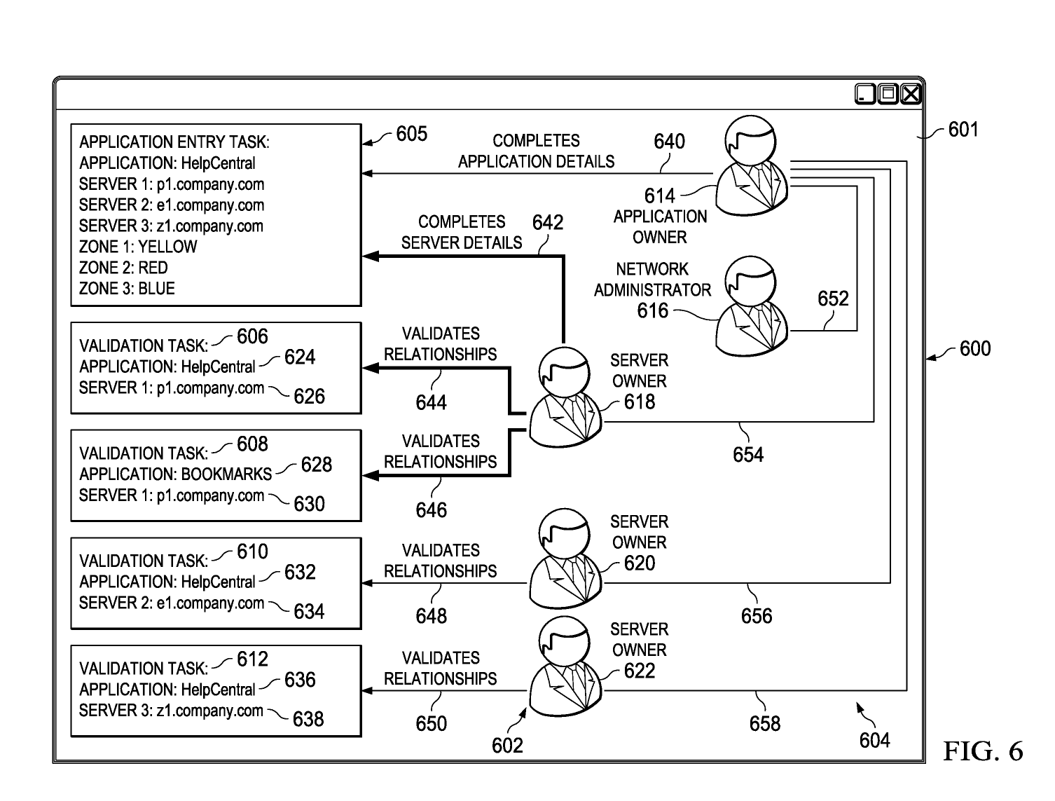

With reference now to FIG. 6, an illustration of a model for a project is depicted in accordance with an illustrative embodiment. In this illustrative example, model 600 is an example of one implementation for model 316 in FIG. 3. Further, model 600 may be for a project, such as project 306 in FIG. 3. In this illustrative example, model 600 takes the form of project graph 601.

Model 600 includes nodes 602 and links 604. Nodes 602 include application entry task 605, validation task 606, validation task 608, validation task 610, validation task 612, application owner 614, network administrator 616, server owner 618, server owner 620, and server owner 622. Application entry task 605 is performed to identify a number of servers hosting a particular application. In this example, the application is entitled HelpCentral.

Validation tasks 606, 608, 610, and 612 are for validating the relationships between an application and the server hosting the application. A relationship is validated by determining that a server does host the application in question.

For example, validation task 606 is performed to validate that application 624 is hosted by server 626. Validation task 608 is performed to validate that application 628 is hosted by server 630. Validation task 610 is performed to validate that application 632 is hosted by server 634. Validation task 612 is performed to validate that application 636 is hosted by server 638.

In this illustrative example, links 604 identify dependencies between nodes 602. Links 604 include links 640, 642, 644, 646, 648, and 650. Links 640, 642, 644, 646, 648, and 650 identify the people having the knowledge to perform certain tasks.

For example, link 640 and link 642 indicate that application owner 614 and server owner 618, respectively, have the knowledge to perform application entry task 605. Link 644 indicates that server owner 618 has the knowledge to perform validation task 606, and link 646 indicates that server owner 618 has the knowledge to perform validation task 608. Link 648 indicates that server owner 620 has the knowledge to perform validation task 610. Link 650 indicates that server owner 622 has the knowledge to perform validation task 612.

In this illustrative example, links 604 also include links 652, 654, 656, and 658. Links 652, 654, 656, and 658 identify a sharing of knowledge between the people having the knowledge to perform the tasks. In other words, each of links 652, 654, 656, and 658 indicates that information is shared between two people. The information may be shared by the two people possessing the same information, exchanging the information, having the ability to access the same information, or in some other suitable manner.

For example, link 652 indicates that information is shared between application owner 614 and network administrator 616. Link 654 indicates that information is shared between application owner 614 and server owner 618. Link 656 indicates that information is shared between application owner 614 and server owner 620. Link 658 indicates that information is shared between application owner 614 and server owner 622.

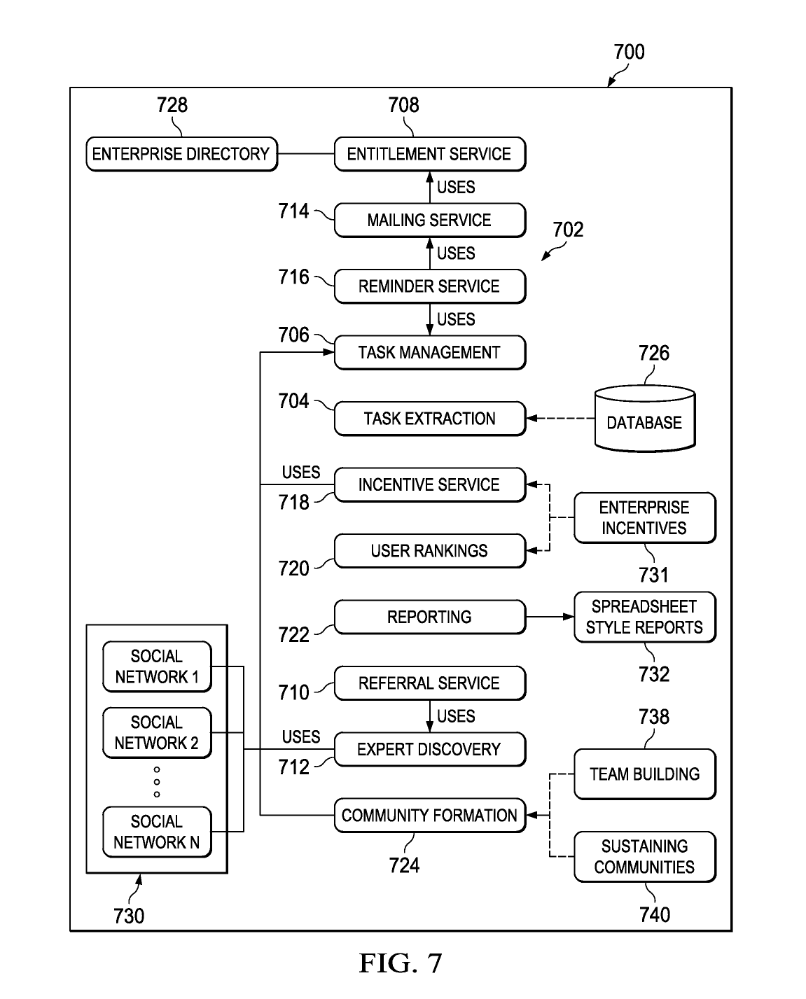

With reference now to FIG. 7, an illustration of a project architecture is depicted in accordance with an illustrative embodiment. In this illustrative example, project architecture 700 is for managing a project, such as project 306 in FIG. 3 and/or project 500 in FIG. 5. Project architecture 700 includes processes 702 for managing the project. The project is for an enterprise. In this illustrative example, the enterprise may be, for example, organization 304 in FIG. 3.

As depicted, processes 702 include task extraction 704, task management 706, entitlement service 708, referral service 710, expert discovery 712, mailing service 714, reminder service 716, incentive service 718, user rankings 720, reporting 722, and community formation 724. Processes 702 are performed such that the project may be completed.

In this illustrative example, task extraction 704 uses information stored in database 726 to identify people who have knowledge about a plurality of tasks for the project. Database 726 may be, for example, expert database 326 in FIG. 3. Database 726 may have a listing of experts having knowledge about the plurality of tasks along with their skills, ratings, reviews, and/or contributions to past and/or current projects, and/or other suitable information. In these illustrative examples, task management 706 sends tasks to people, tracks the status of those tasks, and coordinates the completion of the tasks for the project.

Entitlement service 708 determines whether the people identified by task extraction 704 are part of the enterprise and able to perform tasks in the plurality of tasks. Entitlement service 708 makes this determination using information stored in enterprise directory 728. Enterprise directory 728 may be, for example, a listing of people currently employed by the enterprise.

When a task in the plurality of tasks cannot be performed by a person identified by task extraction 704 and/or entitlement service 708, referral service 710 generates a number of requests to a number of users who are able to perform the task. These requests may also be known as referrals. Referral service 710 uses expert discovery 712 to determine to whom to forward the request. In addition, referral service 710 may be used directly by forwarding the request to people known to have knowledge about the task.

For example, expert discovery 712 may query social networks 730 to determine who has the knowledge to perform the task. Based on the results of expert discovery 712, referral service 710 forwards the request to the number of users who are able to perform the task. Social networks 730 may include social networks outside of the enterprise.

Mailing service 714 sends requests to the people in the enterprise who have the knowledge to perform the plurality of tasks and referrals generated by referral service 710 to the people not in the enterprise who have the knowledge to perform the plurality of tasks. Further, mailing service 714 receives responses from the people. Mailing service 714 also sends instructions to people for performing the plurality of tasks.

Reminder service 716 may send reminders over time to let people know the dates by which to perform certain tasks. Incentive service 718 awards enterprise incentives 731 to people who contribute to a task. In other words, people may receive enterprise incentives 731 for performing a task or helping perform a task. In these examples, task management 706 may be used to actually award enterprise incentives 731 to the people.

User rankings 720 record which of the people contributed the most to the tasks. In other words, the people performing the plurality of tasks may be ranked based on their level of contribution to the project and/or the quality of their contributions. Reporting 722 sends out spreadsheet-style reports 732 to clients. For example, spreadsheet-style reports 732 may contain project status updates, consolidated data views, and/or other suitable information.

Community formation 724 generates data for the people who perform the plurality of tasks and the people who have the knowledge to perform the plurality of tasks. The information generated by community formation 724 may be stored in, for example, database 726. Further, community formation 724 uses team building 738 and sustaining communities 740 to generate this data. Team building 738 may form teams of people in a community. The community may be a set of people for performing and completing a project. For example, team building 738 may build a team for a group of people able to perform a certain type of task and another team for a group of people able to perform a different type of task. Sustaining communities 740 may be used to manage the teams in the community by running competitions for project enhancements and/or continuously attracting new contributors.

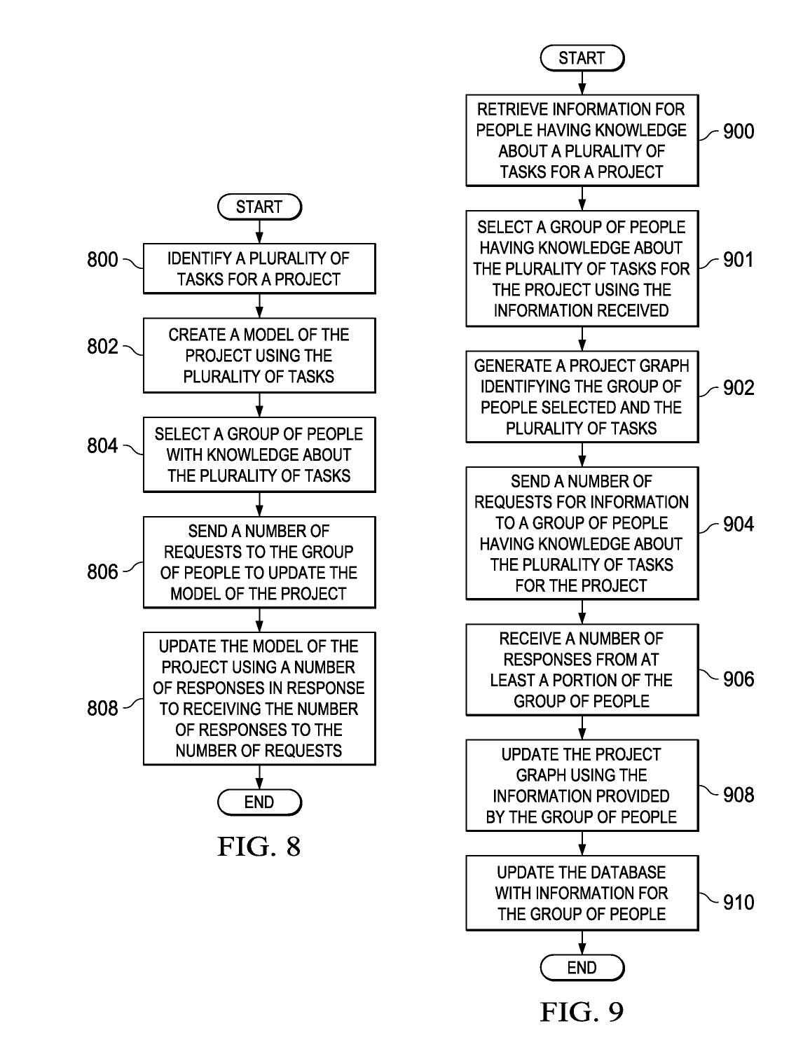

With reference now to FIG. 8, an illustration of a flowchart of a process for managing projects in a network data processing system is depicted in accordance with an illustrative embodiment. The process illustrated in FIG. 8 may be implemented for data processing system 200 in FIG. 2 and/or network data processing system 302 in FIG. 3. The process may be for managing projects, such as project 306 in FIG. 3 and/or project 500 in FIG. 5.

The process begins by identifying a plurality of tasks for a project (step 800). The plurality of tasks may be, for example, plurality of tasks 308 in FIG. 3. Further, the plurality of tasks may be one of the tasks for number of processes 501 in FIG. 5.

The process then creates a model of the project using the plurality of tasks (step 802). The model created in step 802 may be, for example, model 600 in FIG. 6. The model includes the plurality of tasks and identifies the people having knowledge to perform the plurality of tasks. These people may be identified from a database of experts, such as expert database 326 in FIG. 3. The experts may include, for example, experts 538 in FIG. 5.

Thereafter, the process selects a group of people with knowledge about the plurality of tasks (step 804). The group of people may be a sub-set of the people identified in the model of the project or may be all of the people identified in the model of the project. The process then sends a number of requests to the group of people to update the model of the project (step 806). In step 806, the number of requests includes the model.

The process then updates the model of the project using a number of responses in response to receiving the number of responses to the number of requests (step 808), with the process terminating thereafter. In step 808, the number of responses may be received from at least a portion of the group of people.

The model for the project is updated using the number of responses such that the model provides the most current and up-to-date information identifying the people having the knowledge for performing the plurality of tasks for the project.

With reference now to FIG. 9, a flowchart of a process for updating a project graph is depicted in accordance with an illustrative embodiment. The process illustrated in FIG. 9 may be implemented in people cloud environment 300 in FIG. 3. Further, the process may be implemented to update a project graph, such as project graph 320 in FIG. 3.

The process begins by retrieving information for people having knowledge about a plurality of tasks for a project (step 900). The information may include, for example, an identification of the people having the knowledge to perform particular tasks, past project contributions in terms of reviews for the people, ratings for the people, and/or other suitable information. In step 900, the information may be retrieved from a database, such as expert database 326 in FIG. 3 and/or database 418 in FIG. 4. Further, the information may be retrieved from online enterprise sources, such as, for example, without limitation, discussion forums, blogs, and/or other online sources.

The process then selects a group of people having knowledge about the plurality of tasks for the project using the information received (step 901). The process generates a project graph identifying the group of people selected and the plurality of tasks (step 902). The project graph may be, for example, project graph 320 in FIG. 3 and/or project graph 601 in FIG. 6. In step 902, the project graph generated has nodes and links. The nodes may represent people, tasks, and/or a combination of both people and tasks. The links represent dependencies between the nodes.

Thereafter, the process sends a number of requests for information to a group of people having knowledge about the plurality of tasks for the project (step 904). The number of requests includes the project graph in these illustrative examples. The information requested may include, for example, a list of contributions by each of the group of people for past projects and/or the current project, a list of skills for each of the group of people, additional people that may have knowledge about the plurality of tasks, and/or other suitable information.

The process then receives a number of responses from at least a portion of the group of people (step 906). The process updates the project graph using the information provided by the group of people (step 908). The updating of the project graph may include, for example, new nodes, new links, changes to nodes, changes to links, removal of nodes, removal of links, and/or other updates.

Thereafter, the process may update the database with information for the group of people (step 910), with the process terminating thereafter. The information updated to the database may include a confidence level for the group of people, a record of the contributions for the group of people, and/or other suitable information.

The process illustrated in FIG. 9 may be performed for the duration of the project. In this manner, the project graph may be updated with the most current and up-to-date information for the plurality of tasks for the project and the people involved with the project.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment, or an embodiment containing both hardware and software elements. In a preferred embodiment, the invention is implemented in software, which includes, but is not limited to, firmware, resident software, microcode, etc.

Furthermore, the invention can take the form of a computer program product accessible from a computer usable or computer readable medium providing program code for use by or in connection with a computer or any instruction system. For the purposes of this description, a computer usable or computer readable medium can be any tangible apparatus that can contain, store, communicate, propagate, or transport the program for use by or in connection with the instruction system, apparatus, or device.

The medium can be an electronic, magnetic, optical, electromagnetic, infrared, or semiconductor system (or apparatus or device) or a propagation medium. Examples of a computer readable medium include a semiconductor or solid state memory, magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

A data processing system suitable for storing and/or executing program code will include at least one processor coupled directly or indirectly to memory elements through a system bus. The memory elements can include local memory employed during actual running of the program code, bulk storage, and cache memories, which provide temporary storage of at least some program code in order to reduce the number of times code must be retrieved from bulk storage during running of the code.

Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, or storage devices through intervening networks. Modems, cable modem, and Ethernet cards are just a few of the currently available types of network adapters.

The description of the present invention has been presented for purposes of illustration and description, and it is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for managing projects in a network data processing system, the method comprising:
identifying, by a computer system, a plurality of tasks for a project;
creating, by the computer system, a model for the project using the plurality of tasks, wherein the model identifies people to perform the plurality of tasks;
selecting, by the computer system, a group of people with knowledge about the plurality of tasks;
sending, by the computer system, a number of requests to the group of people to update the model of the project, wherein the number of requests includes the model; and
responsive to receiving a number of responses to the number of requests, updating, by the computer system, the model of the project using the number of responses.

2. The method of claim 1, wherein the step of sending, by the computer system, the number of requests to the group of people to update the model of the project comprises:
sending, by the computer system, the number of requests to the group of people to update the model of the project, wherein the number of requests includes an identification of missing information in the model.

3. The method of claim 1, wherein the step of selecting, by the computer system, the group of people with the knowledge about the plurality of tasks comprises:
querying a database of experts for an identification of a number of people for the plurality of tasks; and
selecting the group of people from results received from the database of experts.

4. The method of claim 1, wherein the step of creating, by the computer system, the model for the project using the plurality of tasks, wherein the model identifies the people to perform the plurality of tasks comprises:
identifying nodes and links between the nodes for the model using the plurality of tasks, wherein each node identifies at least one of a task and a person and each link identifies a dependency between two nodes.

5. The method of claim 1 further comprising:
displaying the model in the network data processing system in a graphical user interface to at least a portion of the group of people; and
receiving user input to the model through the graphical user interface from the at least a portion of the group of people.

6. The method of claim 5, wherein the user input provides at least one of a new node, a new link, a deletion of a node, a deletion of a link, a value of an attribute for the node, and a value of an attribute for the link.

7. The method of claim 1 further comprising:
performing the project using the model after the model is completed.

8. The method of claim 1, wherein the number of requests are sent to the group of people while the project is being performed.

9. A data processing system comprising:
a bus;
a storage device connected to the bus, wherein program code is stored on the storage device; and
a processor unit connected to the bus, wherein the processor unit runs the program code to identify a plurality of tasks for a project; create a model for the project using the plurality of tasks, wherein the model identifies people to perform the plurality of tasks; select a group of people with knowledge about the plurality of tasks; send a number of requests to the group of people to update the model of the project, wherein the number of requests include the model; and update the model of the project using a number of responses in response to receiving the number of responses to the number of requests.

10. The data processing system of claim 9, wherein in running the program code to send the number of requests to the group of people to update the model of the project, the processor unit runs the program code to send the number of requests to the group of people to update the model of the project, wherein the number of requests includes an identification of missing information in the model.

11. The data processing system of claim 9, wherein in running the program code to select the group of people with the knowledge about the plurality of tasks, the processor unit runs the program code to query a database of experts for an identification of a number of people for the plurality of tasks and select the group of people from results received from the database of experts.

12. The data processing system of claim 9, wherein in running the program code to create the model for the project using the plurality of tasks, wherein the model identifies the people to perform the plurality of tasks, the processor unit runs the program code to identify nodes and links between the nodes for the model using the plurality of tasks, wherein each node identifies at least one of a task and a person and each link identifies a dependency between two nodes.

13. The data processing system of claim 9, wherein the processor unit further runs the program code to display the model in the data processing system in a graphical user interface to at least a portion of the group of people; and receive user input to the model through the graphical user interface from the at least a portion of the group of people.

14. The data processing system of claim 13, wherein the user input provides at least one of a new node, a new link, a deletion of a node, a deletion of a link, a value of an attribute for the node, and a value of an attribute for the link.

15. The data processing system of claim 9 wherein the processor unit further runs the program code to perform the project using the model after the model is completed.

16. The data processing system of claim 9, wherein the number of requests are sent to the group of people while the project is being performed.

17. A computer program product for managing projects in a network data processing system, the computer program product comprising:
a computer recordable storage medium;
program code, stored on the computer recordable storage medium, for identifying, by a computer system, a plurality of tasks for a project;
program code, stored on the computer recordable storage medium, for creating a model for the project using the plurality of tasks, wherein the model identifies people to perform the plurality of tasks;
program code, stored on the computer recordable storage medium, for selecting a group of people with knowledge about the plurality of tasks;
program code, stored on the computer recordable storage medium, for sending a number of requests to the group of people to update the model of the project, wherein the number of requests include the model; and
program code, stored on the computer recordable storage medium, for updating the model of the project using a number of responses in response to receiving the number of responses to the number of requests.

18. The computer program product of claim 17, wherein the program code, stored on the computer recordable storage medium, for sending the number of requests to the group of people to update the model of the project comprises:
program code, stored on the computer recordable storage medium, for sending the number of requests to the group of people to update the model of the project, wherein the number of requests includes an identification of missing information in the model.

19. The computer program product of claim 17, wherein the program code, stored on the computer recordable storage medium, for selecting the group of people with the knowledge about the plurality of tasks comprises:
program code, stored on the computer recordable storage medium, for querying a database of experts for an identification of a number of people for the plurality of tasks; and
program code, stored on the computer recordable storage medium, for selecting the group of people from results received from the database of experts.

20. The computer program product of claim 17, wherein the program code, stored on the computer recordable storage medium, for creating the model for the project using the plurality of tasks, wherein the model identifies the people to perform the plurality of tasks comprises:
program code, stored on the computer recordable storage medium, for identifying nodes and links between the nodes for the model using the plurality of tasks, wherein each node identifies at least one of a task and a person and each link identifies a dependency between two nodes.

21. The computer program product of claim 17 further comprising:
program code, stored on the computer recordable storage medium, for displaying the model in the network data processing system in a graphical user interface to at least a portion of the group of people; and
program code, stored on the computer recordable storage medium, for receiving user input to the model through the graphical user interface from the at least a portion of the group of people.

22. The computer program product of claim 21, wherein the user input provides at least one of a new node, a new link, a deletion of a node, a deletion of a link, a value of an attribute for the node, and a value of an attribute for the link.

23. The computer program product of claim 17 further comprising:
program code, stored on the computer recordable storage medium, for performing the project using the model after the model is completed.

24. The computer program product of claim 17, wherein the number of requests are sent to the group of people while the project is being performed.
